(19) United States
(12) Patent Application Publication
(10) Pub. No.: US 2015/0166855 A1
(43) Pub. Date: Jun. 18, 2015

(54) ADHESIVE COMPOSITION CONTAINING UV CURABLE RUBBER, AND PROTECTIVE FILM USING SAME

(71) Applicant: LG Hausys, Ltd., Yeongdeungpo-gu, Seoul (KR)

(72) Inventors: Sle Lee, Incheon (KR); Jang Soon Kim, Seongnam-si (KR); Ae Jung Jang, Anyang-si (KR)

(73) Assignee: LG Hausys, Ltd., Yeongdeungpo-gu, Seoul (KR)

(21) Appl. No.: 14/401,675

(22) PCT Filed: Dec. 13, 2012
(86) PCT No.: PCT/KR2012/010850

§ 371 Date: Nov. 17, 2014

(30) Foreign Application Priority Data
Jun. 21, 2012 (KR) 10-2012-0066749

(51) Int. Cl. C09J 153/02; C09J 7/02

(52) U.S. Cl. CPC C09J 153/02; C09J 7/0285; C09J 7/0267; C09J 7/0271; C09J 7/0282; C09J 7/026; C09J 2201/122; C09J 2453/00; C09J 2467/006; C09J 2425/006; C09J 2423/006; C09J 2469/006; C09J 2479/086; C09J 2481/006; C09J 2405/006; C09J 2433/006

(57) ABSTRACT

The present invention provides an adhesive composition for a protective film, comprising a UV curable rubber having a degree of unsaturation of 70-85%. In addition, the present invention provides a protective film formed with the adhesive composition for a protective film.

### TECHNICAL FIELD

The present invention relates to an adhesive composition for protective films. More particularly, the present invention relates to an adhesive composition for protective films including a UV curable rubber, and a protective film using the same.

### BACKGROUND ART

For surface protection of various displays transferred for operation on a worktable, protective films are attached to surfaces of the displays, such as polarizing films, which are one component of flat panel displays (FPDs), protective windows of mobile phones, and the like. Here, a layer directly contacting an adherend is an adhesive layer regardless of a layer structure of the protective film, and properties of the adhesive layer are a very important factor in determination of adhesion to the adherend, adhesive transfer, and the like.

When the protective film is removed, there is a problem in that the adhesive layer is partially attached to the adherend rather than uniformly attached thereto. On the other hand, when the adhesive layer is peeled off, the adherend can suffer from contamination or residues thereon.

Although Si polymers are used in the art to impart maximum wettability for facilitation of peeling-off and bonding of the adhesive layer, the Si polymers have a problem in mass production due to high price. In addition, when silicone oil is used to additionally impart wettability, there is a problem of deterioration in touch sensitivity of touch panels to which an adhesive composition is applied, since the oil is transferred to the surface of the touch panel and causes contamination.

Moreover, although Korean Patent No. 10-0826420 discloses an adhesive film composition for semiconductor assembly including a rubber, a phenol resin, a vulcanizer, fillers and an organic solvent, this document discloses merely an adhesive film capable of maintaining reliability of products through maintenance of adhesion of the adhesive film, and there are still problems relating to securing wettability and residues after separating the adhesive film.

### DISCLOSURE

### Technical Problem

The present invention is conceived to solve such problems in the art, and it is an aspect of the present invention to provide an adhesive composition for protective films, which secures a certain level or higher of wettability and does not cause residues on an adherend while maintaining adhesion even after high temperature and high humidity treatment.

### Technical Solution

In accordance with one aspect of the present invention, an adhesive composition for protective films includes a UV curable rubber having a degree of unsaturation from 70% to 85%.

In accordance with another aspect of the present invention, a protective film includes the adhesive composition set forth above.

### Advantageous Effects

Since the adhesive composition according to the present invention includes the UV curable rubber having a limited degree of unsaturation, the adhesive composition can secure a certain level or higher of wettability. Thus, the adhesive composition can significantly reduce residues on an adherend thereof after peeling-off while maintaining adhesion even after high temperature and high humidity treatment.

In addition, the protective film including the adhesive composition exhibiting excellent properties in terms of both bonding and peeling-off is used, thereby significantly reducing process loss.

### BEST MODE

The above and other aspects, features, and advantages of the present invention will become apparent from the detailed description of the following embodiments. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof. Like components will be denoted by like reference numerals throughout the specification.

Hereinafter, embodiments of the present invention will be described in detail.

Adhesive Composition for Protective Films

In accordance with one aspect of the present invention, an adhesive composition for protective films includes a UV curable rubber having a degree of unsaturation from 70% to 85%.

Since an amount of double bonds included in the UV curable rubber is limited, the adhesive composition can exhibit an increased degree of curing, and since the adhesive composition includes a certain level or higher of double bonds, the adhesive composition can secure wettability. Here, the amount of the double bonds in the UV curable rubber is indicated by a degree of saturation, and the degree of saturation represents the amount of double bonds in overall compositions of the UV curable rubber in %.

The degree of saturation can control a degree of curing of the UV curable rubber. If the degree of saturation is not limited even though the UV curable rubber is used, it is difficult to determine properties of the rubber since the content of polymers determining basic properties of the rubber is not known, and there can be a problem in adjustment of an amount of an added curing agent since it is difficult to determine the presence of the rubber in the adhesive composition. Therefore, according to the present invention, the UV curable rubber has a degree of unsaturation from 70% to 85%. More specifically, if the degree of unsaturation of the UV curable rubber is less than 70%, there is a concern of deterioration in durability of the adhesive composition at high temperature, and if the degree of unsaturation of the UV curable rubber is greater than 85%, there is a problem of deterioration in adhesion of an adhesive since the adhesive exhibits higher hardness with increasing degree of curing of the double bonds.

Typically, to impart wettability to an adhesive composition, a silicone adhesive composition is used or silicone oil is used and thermal curing is performed. On the other hand, since the rubber-based adhesive composition according to the present invention has a limited degree of saturation, which indicates the amount of double bonds, the rubber-based adhesive composition overcomes a drawback of a low degree of curing of rubbers, maintains excellent adhesion by securing wettability even after high temperature and high humidity treatment, and does not provide residues when peeled off.

In addition, unlike typical adhesive compositions including an expensive silicone resin and various additives such as silicone oil to impart wettability, the adhesive composition for protective films according to the present invention, in which the degree of saturation of the UV curable rubber is limited, does not require separate aging, treatment, additional additives, and the like.

The UV curable rubber may be any rubber and may include at least one selected from the group consisting of isoprene, styrene, polybutadiene, acrylonitrile butadiene, butyl, polychloroprene, urethane, and acrylic rubbers.

Preferably, the UV curable rubber is a styrene rubber exhibiting high hardness since the styrene rubber forms a double-bond ring. The styrene rubber may include at least one selected from the group consisting of styrene-isoprene-styrene block copolymers, styrene-butadiene-styrene block copolymers, styrene-butylene-styrene block copolymers, styrene-propylene-styrene block copolymers, acrylonitrile-butylene-styrene copolymers, and carboxylic acid derivatives thereof.

More specifically, the styrene rubber may include styrene in an amount of 15% to 30%. If the amount of styrene is greater than 30%, there is a problem of deterioration in adhesion of the adhesive due to high hardness thereof. In addition, the amount of styrene may be 15% or more in terms of durability of the adhesive.

According to the present invention, the adhesive composition for protective films includes the UV curable rubber, which has a limited degree of saturation, as a main component, and the UV curable rubber has a weight average molecular weight from 30,000 to 60,000. If the weight average molecular weight of the UV curable rubber is less than 30,000, there is a problem of deterioration in durability of the adhesive composition upon UV curing, and if the weight average molecular weight of the UV curable rubber is greater than 60,000, there is a concern of deterioration in peel strength of the adhesive composition since a degree of curing thereof is increased due to long polymer length.

The UV curable rubber has a glass transition temperature (Tg) from −60° C. to −40° C. Since the adhesive composition according to the present invention includes the rubber and has a lower Tg than typical acrylic resins, the adhesive composition exhibits better heat resistance and cold resistance due to the low Tg thereof. More specifically, if the glass transition temperature of the UV curable rubber is less than −60° C., it is difficulty to secure durability of the adhesive composition, and if the glass transition temperature of the UV curable rubber is greater than −40° C., there is a problem in low temperature properties of the adhesive composition.

In addition, the UV curable rubber may have a surface energy from 30 mN/m to 40 mN/m. Surface energy is a factor having the greatest influence on wettability, and since the UV curable rubber maintains a low surface energy, the adhesive composition exhibits excellent wettability to most substrates or adherends. More specifically, if the surface energy of the UV curable rubber is less than 30 mN/m, the adhesive composition can exhibit low peel strength with respect to substrates or adherends having relatively low surface energy, and if the surface energy of the UV curable rubber is greater than 40 mN/m, there can be a problem in properties of substrates or adherends having relatively high surface energy.

The adhesive composition according to the present invention may further include a photopolymerization initiator. Thus, the adhesive composition may be cured by irradiation for an extremely short time using active energy rays such as UV rays and the like, and be adjusted in terms of weight average molecular weight. The photopolymerization initiator allows the adhesive composition to be cured by heating. When the photopolymerization initiator is used, photocuring and thermal curing may be jointly used as needed, although curing rate can be slow and it is difficult to adjust the molecular weight of the adhesive composition.

Examples of the photopolymerization initiator may include: acetophenones, such as diethoxyacetophenone, 2-hydroxy-2-methyl-1-phenylpropan-1-one, benzyl dimethyl ketal, 4-(2-hydroxyethoxyl)phenyl-(2-hydroxy-2-propyl) ketone, 1-hydroxycyclohexyl phenyl ketone, 2-methyl-2-morpholino(4-thiomethylphenyl)propan-1-one, 2-benzyl-2-dimethylamino-1-(4-morpholinophenyl)butanone, 2-hydroxy-2-methyl-1-oligomers, and the like; benzoins, such as benzoin, benzoin methyl ether, benzoin ethyl ether, benzoin isopropyl ether, benzoin isobutyl ether, and the like; benzophenones, such as benzophenone, methyl o-benzoyl benzoate, 4-phenylbenzophenone, 4-benzoyl-4′-methyl-diphenylsulfide, 3,3′,4,4′-tetra(t-butylperoxycarbonyl)benzophenone, 2,4,6-trimethylbenzophenone, 4-benzoyl-N,N-dimethyl-N-[2-(1-oxo-2-propenyl oxy)ethyl]benzene methane ammonium bromide, (4-benzoylbenzyl)trimethylammonium chloride, and the like; thioxanthones, such as 2-isopropylthioxanthone, 4-isopropylthioxanthone, 2,4-diethylthioxanthone, 2,4-dichlorothioxanthone, 1-chloro-4-propoxythioxanthone, 2-(3-dimethylamino-2-hydroxy)-3,4-dimethyl-9H-thioxanthone-9-one mesochloride, and the like; acylphosphone oxides, such as 2,4,6-trimethylbenzoyl-diphenylphosphine oxide, bis(2,6-dimethoxybenzoyl)-2,4,4-trimethyl-pentylphosphine oxide, bis(2,4,6-trimethylbenzoyl)-phenylphosphine oxide, and the like, without being limited thereto. These photopolymerization initiators may be used alone or in combination thereof.

In addition, aids of the photopolymerization initiator may include triethanolamine, triisopropanolamine, 4,4′-dimethylaminobenzophenone (Michler's ketone), 4,4′-diethylaminobenzophenone, 2-dimethylaminoethylbenzoate, ethyl 4-dimethylaminobenzoate, (n-butoxy)ethyl 4-dimethylaminobenzoate, isoamyl 4-dimethylaminobenzoate, 2-ethylhexyl 4-dimethylaminobenzoate, 2,4-diethylthioxanthone, 2,4-diisopropylthioxanthone, and the like.

Preferably, the photopolymerization initiator includes benzyl dimethyl ketal, 1-hydroxycyclohexyl phenyl ketone, benzoylisopropylether, 4-(2-hydroxyethoxy)-phenyl(2-hydroxy-2-propyl) ketone, and 2-hydroxy-2-methyl-1-phenylpropan-1-one.

As for the content of the photopolymerization initiator, the adhesive composition according to the present invention may further include 0.1 parts by weight to 1 part by weight of the photopolymerization initiator based on 100 parts by weight of the UV curable rubber. If the amount of the photopolymerization initiator is less than 0.1 parts by weight, there is a problem in durability of the adhesive composition after curing due to a low degree of curing thereof, and if the amount of the photopolymerization initiator is greater than 1 part by weight, there is a concern of low peel strength of the adhesive composition after curing due to a high degree of curing thereof.

Protective Film

In accordance with another aspect of the present invention, a protective film is formed of an adhesive composition for protective films, which includes a UV curable rubber having a degree of unsaturation from 70% to 85%.

According to the present invention, the protective film may be prepared from the adhesive composition using any typical method known in the art. For example, the adhesive composition may be coated onto a substrate, followed by drying for a predetermined period of time to remove an organic solvent, thereby preparing a protective film.

The substrate, onto which the adhesive composition is coated, may include ester polymer films including polyethylene terephthalate, styrene polymer films including polystyrene, olefin polymer films including cycloolefin polymers, carbonate polymer films including polycarbonate, imide polymer films including polyimide, sulfone polymer films including polyethersulfone, cellulose polymer films including triacetyl cellulose, acrylic polymer films including polymethyl methacrylate, and the like. However, the substrate may be any polymer film used as a base film for protective films or adhesive films without limitation.

According to the present invention, the adhesive composition may also be used for functional protective films in which functionality is imparted to another layer other than an adhesive layer. For example, the adhesive composition may be applied to antistatic protective films in which antistatic properties are imparted to a surface to be coated with an adhesive, and to protective films in which other functions, such as antistatic properties, water repellency, anti-contamination and the like, are imparted to an opposite surface to the surface coated with the adhesive.

Since the adhesive composition relates to a technique for adjusting properties of the adhesive layer, the adhesive composition can be used regardless of functionality imparted to other layers other than the adhesive layer. For example, an antistatic agent including a conductive polymer as an active component may be used for an interlayer between the adhesive layer and the base film to impart antistatic properties, and the conductive polymer may be poly(3,4-ethylenedioxythiophene).

Although the present invention has been described with reference to some embodiments, it should be understood that various modifications, changes, alterations, and equivalent embodiments can be made by those skilled in the art without departing from the spirit and scope of the invention. Therefore, the scope of the invention should be limited only by the accompanying claims and equivalents thereof.

### EXAMPLES AND COMPARATIVE EXAMPLES

### Example 1

0.5 parts by weight of Irgacure 651 as a photopolymerization initiator and 1 part by weight of HDDA as a curing agent were added to 100 parts by weight of an SBS resin composed of a styrene-butadiene-styrene block copolymer and had a degree of unsaturation of 82%, followed by drying a toluene solvent. Then, the resulting material was subjected to UV curing, thereby preparing an adhesive composition.

### Example 2

An adhesive composition was prepared in the same manner as in Example 1 except that an SBS resin composed of a styrene-butadiene-styrene block copolymer and having a degree of unsaturation of 70% was used.

### Example 3

0.5 parts by weight of Irgacure 651 as a photopolymerization initiator, and 1 part by weight of HDDA as a curing agent were added to 100 parts by weight of an SIS resin composed of a styrene-isoprene-styrene block copolymer and having a degree of unsaturation of 76%, followed by drying a toluene solvent. Then, the resulting material was subjected to UV curing, thereby preparing an adhesive composition.

### Example 4

An adhesive composition was prepared in the same manner as in Example 3 except that an SIS resin composed of a styrene-isoprene-styrene block copolymer and having a degree of unsaturation of 85% was used.

### Comparative Example 1

60 parts by weight of a vinyl siloxane-based silicone polymer (Dow Corning Co., Ltd.), 40 parts by weight of a polydimethylsiloxane (PDMS)-based silicone adhesive, 7 parts by weight of a hydrogen polysiloxane resin (Dow Corning Co., Ltd.), and 1 part by weight of a platinum catalyst were mixed based on 100 parts by weight of a silicone adhesive composition, followed by drying while supplying hot air, thereby preparing a silicone adhesive composition.

### Comparative Example 2

A silicone adhesive composition was prepared in the same manner as in Comparative Example 1 except that 5 parts by weight of silicone oil was added to 100 parts by weight of the silicone adhesive composition of Comparative Example 1.

### Comparative Example 3

An adhesive composition for protective films was prepared in the same manner as in Example 1 except that the SBS resin had a degree of unsaturation of 90%.

### Comparative Example 4

An adhesive composition for protective films was prepared in the same manner as in Example 1 except that the SIS resin of Example 2 had a degree of unsaturation of 60%.

TABLE 1

| | | Degree of | | | |
|---|---|---|---|---|---|
| | | unsatu- | Photo- | Curing | Curing |
| | Resin | ration (%) | initiator | agent | method |
| Example 1 | SBS | 82 | Irgacure 651 | HDDA | Solvent |
| | | | | | drying, |
| | | | | | followed |
| | | | | | by UV |
| Example 2 | SBS | 70 | Irgacure 651 | HDDA | Solvent |
| | | | | | drying, |
| | | | | | followed |
| | | | | | by UV |
| Example 3 | SIS | 76 | Irgacure 651 | HDDA | Solvent |
| | | | | | drying, |
| | | | | | followed |
| | | | | | by UV |
| Example 4 | SIS | 85 | Irgacure 651 | HDDA | Solvent |
| | | | | | drying, |
| | | | | | followed |
| | | | | | by UV |
| Compara- | Silicone | — | — | BPO | Hot air |
| tive | adhesive | | | | |
| Example 1 | composition | | | | |
| Compara- | Silicone | — | — | Pt | Hot air |
| tive | adhesive | | | | |
| Example 2 | composi- | | | | |
| | tion + Oil | | | | |
| Compara- | SBS | 90 | Irgacure 651 | HDDA | Solvent |
| tive | | | | | drying, |
| Example 3 | | | | | followed |
| | | | | | by UV |
| Compara- | SIS | 60 | Irgacure 651 | HDDA | Solvent |
| tive | | | | | drying, |
| Example 4 | | | | | followed |
| | | | | | by UV |

### Experimental Example

### Physical Properties of Protective Film

An adhesive layer was formed of each of the adhesive compositions prepared in Examples and Comparative Examples, followed by drying to a thickness of 20 μm. Next, the adhesive layer was coated onto non-treated PET, thereby forming a protective film. The protective film was evaluated as to the following properties. Results are shown in Table 2.

1) Residue upon PET peeling-off: The protective film was attached to a surface of a glass sheet, and then kept in an oven at a high temperature of 80° C. for one day. Next, PET was peeled off, followed by observing whether the adhesive layer left residues.

2) Wetting rate: The protective film was cut to a size of 10 cm×2.5 cm (length×width), and then placed on a glass sheet. Next, the protective film was pressed at 3 points by hand, followed by measuring time for bonding the entirety of the protective film.

TABLE 2

| | Residue | Wetting rate (seconds) |
|---|---|---|
| Example 1 | None | 3 |
| Example 2 | None | 3 |
| Example 3 | None | 3 |
| Example 4 | None | 3 |
| Comparative Example 1 | None | 6 |
| Comparative Example 2 | Residue generation | 2 |
| Comparative Example 3 | Residue generation | 6 |
| Comparative Example 4 | Residue generation | 6 |

Referring to Table 2, although the adhesive composition of Comparative Example 1, which did not include a UV curable resin, did not generate residues after peeling off, the adhesive composition of Comparative Example 1 had a slower wetting rate of 6 seconds than those of Examples 1 and 2. In addition, although the adhesive composition of Comparative Example 3 had a wetting rate of 2 seconds, this adhesive composition could not overcome problems of typical adhesive compositions by generating residues.

Further, although the adhesive compositions of Comparative Examples 3 and 4 included the UV curable rubber containing the styrene rubber, these adhesive compositions had a degree of unsaturation out of the range of the present invention. In this case, the adhesive compositions of Comparative Examples 3 and 4 generated residues upon peeling-off and had a slow wetting rate. Thus, it could be confirmed that, although the adhesive composition included a UV curable rubber, the adhesive compositions could not provide advantageous effects of the present invention if the degree of unsaturation thereof was not limited.

1. An adhesive composition for protective films, comprising:
a UV curable rubber having a degree of unsaturation from 70% to 85%.

2. The adhesive composition according to claim 1, wherein the UV curable rubber comprises at least one selected from the group consisting of isoprene, styrene, polybutadiene, acrylonitrile butadiene, butyl, polychloroprene, urethane, and acrylic rubbers.

3. The adhesive composition according to claim 2, wherein the styrene rubber comprises at least one selected from the group consisting of styrene-isoprene-styrene block copolymers, styrene-butadiene-styrene block copolymers, styrene-butylene-styrene block copolymers, styrene-propylene-styrene block copolymers, acrylonitrile-butylene-styrene copolymers, and carboxylic acid derivatives thereof.

4. The adhesive composition according to claim 2, wherein the styrene rubber comprises styrene in an amount of 15% to 30%.

5. The adhesive composition according to claim 1, wherein the UV curable rubber has a weight average molecular weight from 30,000 to 60,000.

6. The adhesive composition according to claim 1, wherein the UV curable rubber has a glass transition temperature from −60° C. to −40° C.

7. The adhesive composition according to claim 1, wherein the UV curable rubber has a surface energy from 30 mN/m to 40 mN/m.

8. The adhesive composition according to claim 1, further comprising:
0.1 parts by weight to 1 part by weight of a photopolymerization initiator based on 100 parts by weight of the UV curable rubber.

9. A protective film formed of the adhesive composition according to claim 1.

10. The protective film according to claim 9, wherein a substrate, onto which the adhesive composition is coated, comprises at least one selected from the group consisting of ester polymer films comprising polyethylene terephthalate, styrene polymer films comprising polystyrene, olefin polymer films comprising cycloolefin polymers, carbonate polymer films comprising polycarbonate, imide polymer films comprising polyimide, sulfone polymer films comprising polyethersulfone, cellulose polymer films comprising triacetyl cellulose, and acrylic polymer films comprising polymethyl methacrylate.
